(19) United States
(12) Patent Application Publication
(10) Pub. No.: US 2014/0222398 A1
(43) Pub. Date: Aug. 7, 2014

(54) METHODS AND APPARATUS FOR DOUBLE-INTEGRATION ORTHOGONAL SPACE TEMPERING

(71) Applicant: FLORIDA STATE UNIVERSITY RESEARCH FOUNDATION, INC., TALLAHASSEE, FL (US)

(72) Inventors: Wei YANG, Tallahassee, FL (US); Lianqing Zheng, Tallahassee, FL (US)

(73) Assignee: FLORIDA STATE UNIVERSITY RESEARCH FOUNDATION, INC., TALLAHASSEE, FL (US)

(21) Appl. No.: 14/104,375

(22) Filed: Dec. 12, 2013

Related U.S. Application Data
(63) Continuation-in-part of application No. PCT/US2012/004245, filed on Jun. 14, 2012.
(60) Provisional application No. 61/496,628, filed on Jun. 14, 2011.

(51) Int. Cl. G06F 19/12

(52) U.S. Cl. CPC G06F 19/12
USPC 703/2

(57) ABSTRACT

The orthogonal space random walk (OSRW) algorithm is generalized to be the orthogonal space tempering (OST) method via the introduction of the orthogonal space sampling temperature. A double-integration recursion method enables practically efficient and robust OST free energy calculations, augmented by a θ-dynamics approach. The double-integration OST method performs alchemical free energy simulations, to calculate the free energy difference between benzyl phosphonate and difluorobenzyl phosphonate in aqueous solution, to estimate the solvation free energy of the octanol molecule, and to predict the nontrivial Barnase-Barstar binding affinity change induced by the Barnase N58A mutation. The DI-OST method robustly enables practically efficient free energy predictions, particularly when strongly coupled slow environmental transitions are involved. A classical set of p38α MAP Kinase inhibitors are also employed as a test bed for evaluating relative binding affinity calculation methods. Throughout the molecular dynamics (MD) sampling no human intervention was involved

This application is a continuation in part of International Application Number PCT/US2012/042405 filed Jun. 14, 2012 which claims the benefit of U.S. provisional application Ser. No. 61/496,628, filed Jun. 14, 2011 both of which are incorporated by reference herein and which form a part of the disclosure in this application.

### GOVERNMENT INTERESTS

This invention was made (at least in part) with U.S. Government support under MCB Grant No. 0919983 awarded by the National Science Foundation. The U.S. Government has certain rights in this invention.

### BACKGROUND OF THE INVENTION

1. Field of the Invention

This invention relates broadly to mathematical simulations in molecular biology. More particularly, this invention relates to methods for calculating alchemic free energies to predict the free energy difference between benzyl phosphonate and difluorobenzyl phosphonate in aqueous solution, to estimate the pKₐ, value of a buried titratable residue, Glu-66, in the interior of the V66E staphylococcal nuclease mutant, and to predict the binding affinity of xylene in the T₄ lysozyme L₉₉A mutant and the relative binding affinities of a classical set of p38α MAP Kinase inhibitors.

2. State of the Art

On average it takes 12-15 years and $800 million for a safe and effective new drug to go from a discovery in the lab to the pharmacy. If the costs of drugs which fail partway through the process are accounted for, the price rises to $1.3 billion—for a single drug.

Despite progress made over the past two decades, computational predictions for docking and scoring (molecules and proteins) have yet to meet the necessary level of consistency and accuracy. One recent study of binding affinity predictions states, “Accurate ligand-protein binding affinity prediction, for a set of similar binders, is a major challenge in the lead optimization stage in drug development. In general, docking and scoring functions perform unsatisfactorily in this application.”

Of the approximately 5,000 compounds that enter the medicinal chemistry and drug metabolism and pharmaco-kinetics evaluation phases of drug discovery, only one succeeds and becomes a drug. If prioritization and screening occurred more rapidly, pharmaceutical companies could bring drugs to market more quickly and earn revenue on patented products for more years than with the current technologies.

A drug is generally a small molecule that activates or inhibits the function of a protein or receptor, which in turn results in a therapeutic benefit to a patient. In the most basic sense, drug design involves the design of small molecules that are complementary in shape and charge to the biomolecular target with which they interact and bind. Drug design frequently relies on computer modeling techniques. This type of modeling is often referred to as Computer Aided Drug Design (CADD). Finally, drug design that relies on the knowledge of the three-dimensional structure of the biomolecular target is known as Structure Based Drug Design.

What is really meant by drug design is ligand design, that is, the design of a (small) molecule that will bind tightly to its target. Although modeling techniques for prediction of binding affinity are reasonably successful, there are many other properties, such as bioavailability, metabolic half-life, and lack of side effects, that must be optimized before a ligand can become a safe and efficacious drug.

Structure Based Drug Design is a powerful method for rapidly identifying new lead compounds when a receptor (target) structure is available. In the early stages of drug discovery, virtual high throughput screening (vHTS) can lead to increased efficiency by helping to prioritize compounds in a library and by reducing library size. During the lead optimization stage, accurate docking methods, efficient de novo design methods, and accurate physics-based scoring can yield high-confidence compounds that are more likely to be active in vivo. There are several areas where molecular modeling may prove helpful.

Virtual screening: With Virtual Screening, a large chemical panel is screened against a protein to shortlist those molecules, which may have better binding affinity for the protein. If there is a “hit” with a particular compound, it can be extracted for further in-silico testing and then taken into the laboratory for physical validation. With today's computational resources, several million compounds can be screened in a few days on large clustered computers. Pursuing a handful of promising leads for further development can save researchers considerable time and expense.

Homology modeling: Another common challenge in computer aided drug design research is determining the 3-D structure of proteins. The 3-D structure is known for only a small fraction of proteins. Homology modeling is one method used to predict the protein 3-D structure. If the structure of a specific protein (target) is not known, then it is modeled, based on the known 3-D structures of other similar proteins (templates) using the homology modeling technique.

Quantitative structure activity relationship (QSAR): QSAR is the process by which chemical structures are quantitatively correlated for their biological activity or chemical reactivity, based on well-defined statistical modeling process. The correlations and the statistical models are then used to predict the biological response of the other chemically similar structures.

Drug lead optimization: When a promising lead candidate has been found in a drug discovery program, the next step is to optimize the structure and properties of the potential drug. This usually involves a series of modifications to the primary structure (scaffold) of the compound. This process can be enhanced using software tools that explore related compounds with respect to the lead candidate.

Similarity searches: A common activity in drug discovery is the search for similar chemical compounds. There are variety of methods used in these searches, including sequence similarity, 2D and 3D shape similarity, substructure similarity, electrostatic similarity and others. Several chemo-informatics tools and search engines are available for this work.

Pharmacophore modeling: Pharmacophore is defined as the three-dimensional arrangement of atoms, or groups of atoms, responsible for the biological activity of a drug molecule. Pharmacophore models are constructed, based on compounds of known biological activity and are refined as more data are acquired in an iterative process. The models can be used for optimizing a series of known ligands or, alternatively, they can be used to search molecular databases in order to find new structural classes.

Drug bioavailability and bioactivity: Many drug candidates fail in Phase III clinical trials after many years of research and millions of dollars have been spent on them. And most fail because of toxicity or problems with metabolism. The key characteristics for drugs are absorption, distribution, metabolism, excretion, toxicity and efficacy—i.e. bioavailability and bioactivity. Although, these properties are usually measured in the lab, they can also be predicted in advance with bioinformatics software.

In rational design, docking—the process of positioning a ligand molecule or protein in a receptor binding sites—and scoring—the assessment of the fitness of docked ligands are used to predict binding configuration of active ligands, screen a library of small molecules, and estimate the binding affinities of a compound site. Correct binding configuration offers tremendous insights into the key interaction between ligand and protein molecules and is extremely valuable for understanding the molecular structure activity relationship and for guiding the optimization of the lead compounds.

Despite the progress made over the past two decades, computational predictions for docking and scoring have not yet met the expectation of consistency and accuracy across a wide range of systems. Recent studies have shown that none of the existing docking programs are able to predict experimental binding poses consistently for diverse protein-ligand complexes. Moreover, ranking a series of ligand molecules/proteins is a far more difficult challenge.

There are two major technical obstacles: 1. Reliability of conformational sampling of the complex between ligand (drug or protein) and protein, and 2. Accuracy of predicated binding free energy changes upon the modifications of ligands.

One of key reasons for the modest success using traditional docking methods in predicting the binding affinity is that they are based on ad-hoc sampling and empirical scoring function, which sacrifices prediction reliability for high computational efficiency. The state-of-the-art of computer-aided design methods remain at the qualitative level. As is generally observed, quantitative prediction of relative binding affinities is still not routinely achievable; and even when it is occasionally realized, great “expert insights” and/or large computing resources are usually required. Therefore, pharmaceutical companies are desperate for a quantitative tool, which can reliably predict binding affinity changes upon chemical or biochemical modifications, so as to further improve their interests in potential drug candidate in terms of time, labor, and research cost.

The pharmaceutical ranking of ligand docking molecules historically is a capital intensive billion dollar step in the discovery of clinically relevant drugs. There are many open source software programs and a few commercial software programs for ligand binding prediction. They are based on five underlying approaches: free energy perturbation (FEP), Classical FEP, Monte Carlo, Linear Interaction Energy (LIE) and end-point free energy methods (MM/PBSA).

State of the art computer aided drug design relies on clusters of CPUs and simulation times are on the order of weeks to months. Clearly, the unmet need for the pharmaceutical companies is a software/hardware product that will screen dozens or hundreds of ligands in days with little technical input and a consistent, reliable output that is quantitative and not just qualitative.

The inventors' earlier work is well explained in “Random Walk in Orthogonal Space to Achieve Efficient Free-Energy Simulation Of Complex Systems”, www.pnas.org/cgi/doi/10.1073/pnas.0810631106; PNAS (Proceedings of the National Academy of Sciences of the United States of America) Dec. 23, 2008, vol. 105, no. 51, 20227-20232 which is incorporated by reference herein.

In the past few decades, many ingenious efforts have been made in the development of free-energy simulation methods. Because complex systems often undergo nontrivial structural transition during state switching, achieving efficient free-energy calculation can be challenging. As identified in the prior art, the “Hamiltonian” lagging, which shows that necessary structural relaxation falls behind the order parameter move, has been a primary problem for achieving efficiency in free-energy simulation.

Developing free energy calculation methods has been a focal area in the quantitative aspect of molecular simulation. A major goal is to achieve accurate estimation of target free energy changes within as short as possible sampling length. Facing the bottleneck sampling challenge, various methods have been proposed; among many ingenious efforts, generalized ensemble (GE) based algorithms have attracted tremendous attention. The essential idea of GE free energy simulation methods is to employ a modified ensemble, which permits quick escaping of local energy wells, to efficiently produce accurate distributions for free energy estimations. In classical GE (or the first-order GE) free energy simulations, the design of a modified ensemble is focused on a prechosen order parameter λ, as reflected by the biasing energy term fₘ(λ) in the following target potential shown in Equation (1).

Uₘ=Uₒ(λ)+fₘ(λ) (1)

When λ is a spatial order parameter, Uo(λ) represents the target energy function; when λ is an alchemical order parameter, Uo(λ) stands for a hybrid energy function that is constructed on the basis of the constraints of Uo(0)=UA and Uo(1)=UB (then, two end states A and B are respectively represented by λ=0 and λ=1). In the first-order GE regime, the biasing term fm(λ) is adaptively updated to approach −Go(λ), which is the negative of the λ-dependent free energy profile corresponding to the canonical ensemble with Uo(λ) as the potential energy function; thereby, an order parameter space random walk can be achieved to uniformly sample all the states in a target range. To adaptively estimate Go(λ), three major recursion approaches have been developed; they include the adaptive umbrella sampling method in which free energy estimations are based on order parameter probability distributions, the adaptive biasing force (ABF) method (in alchemical free energy simulations; it is called the generalized ensemble thermodynamic integration method in the molecular dynamics scheme, or the adaptive integration method in the Monte Carlo or hybrid Monte Carlo scheme), in which free energy estimations are based on the thermodynamic integration (TI) formula and the multiplicative approaches (including the metadynamics method for molecular dynamics simulations and the Wang-Landau method for Monte Carlo or hybrid Monte Carlo simulations), which are realized through a dynamic force-balancing relationship. It is noted that various hybrid recursion methods based on the above three major approaches have been explored as well.

Although in first-order GE simulations, free energy surfaces along pre-chosen order parameters are flattened, “hidden” free energy barriers usually exist in the space perpendicular to the order parameter directions. Notably, these “hidden” free energy barriers can impose great sampling challenges, e.g., slow environmental relaxations. As discussed in our earlier works, the generalized force F_{λ} can serve as a collective variable to describe the progress of the hidden processes that strongly couple with the order parameter move. It is noted that F_{λ} is defined as ∂U₀/∂λ−RT (∂ ln|J|/∂λ), where |J| is the Jacobian term corresponding to the transformation from the Cartesian system to a new system with λ as a coordinate direction, and it is equal to ∂U₀/∂x in this model case because of the fact that here an original Cartesian coordinate x is employed as the order parameter. The above insight was originally derived from the Marcus theory; and in our earlier work we generalized the vertical energy gap which was to describe electron transfer processes, to be the generalized force for the description of transitions between neighboring order parameter states; it can be clearly revealed by the spatial-dependent ∂U₀/∂x function. Near the state transition region [xε(−0.5,0.5)], ∂U₀/∂x decreases monotonically with the increase of y. Accordingly, the second-order GE simulation scheme, originally the orthogonal space random walk (OSRW) algorithm, was formulated as shown in the following modified energy function of Equation (2).

Uₘ=U₀(λ)+fₘ(λ)+gₘ(λ,F_{λ}) (2)

where fₘ(λ) is targeted toward −G₀(λ), and gₘ(λ,F_{λ}) is targeted toward G_{0′}(λ,F_{λ}), the negative of the free energy profile along (λ,F_{λ}) in the ensemble corresponding to the energy function U₀(λ)−G₀(λ). It is noted that, different from the first-order GE methods, OSRW requires two recursion components to respectively update gₘ(λ,F_{λ}) and fₘ(λ). The recursion component responsible for the update of gₘ(λ,F_{λ}) is called the “recursion kernel”, and the recursion component responsible for the update of fₘ(λ) is called the “recursion slave” because of the fact that the target of fₘ(λ), −Go(λ), depends on the target of gₘ(λ,F_{λ}): −G₀(λ,F_{λ}). In the original development, the recursion slave was based on the TI formula, and the metadynamics method was employed as the recursion kernel. Notably, in practice, the recursion kernel can be based on any of the three recursion methods as previously mentioned.

Since its birth, the OSRW method has shown very encouraging sampling power; however, the originally implemented method suffers from the lack of robustness, especially in the aspect of long-time scale convergence. Two inter-related aspects contribute to this robustness issue: (1) because of the fact that free energy surfaces along generalized force directions are completely flattened (e.g., the effective sampling temperature in the orthogonal space is infinity), there is no boundary to confine the orthogonal space sampling exploration; (2) the metadynamics-based recursion kernel needs to be replaced by a new more robust recursion strategy.

In our previous work, we proposed a method using a random walk in both the order parameter space and its generalized force space; thereby, the order parameter move and the required conformational relaxation could be efficiently synchronized. As demonstrated in both the alchemical transition and the conformational transition, a leapfrog improvement in free-energy simulation efficiency was obtained. In particular, (i) it solved the notoriously challenging problem of accurately predicting the pKₐ value of a buried titratable residue, Asp-66, in the interior of the V66E staphylococcal nuclease mutant, and (ii) it achieved superior efficiency over the prior metadynamics methods. However, the orthogonal space random walk method proposed in our previous work was not robust enough for practical use.

### SUMMARY OF THE INVENTION

The present invention provides an orthogonal space tempering method which provides robust simulation predictions. The invention also provides a novel recursion kernel which provides much more efficient simulation predictions.

The orthogonal space tempering technique is provided via the introduction of an orthogonal space sampling temperature. Moreover, based on a “dynamic reference restraining” strategy, a novel double-integration recursion method is provided as the recursion kernel to enable practically efficient and robust orthogonal space tempering free energy calculations. The provided double-integration orthogonal space tempering method is demonstrated on alchemical free energy simulations, specifically to calculate the free energy difference between benzyl phosphonate and difluorobenzyl phosphonate in aqueous solution, to estimate the pKₐ value of a buried titratable residue, Glu-66, in the interior of the V66E staphylococcal nuclease mutant, and to predict the binding affinity of xylene in the T₄ lysozyme L₉₉A mutant. The double integration orthogonal space tempering method according to the invention provides unprecedented efficiency and robustness.

The present invention is focused on alchemical free energy simulations by which protein-ligand binding, protein-protein binding, solvation energies, pKa values, and other chemical state related thermodynamic properties can be predicted. However, the double integration orthogonal space tempering method according to the invention is also applicable to geometry-based potential of mean force calculations. The present invention is at least partially described in “Practically Efficient and Robust Free Energy Calculations: Double-Integration Orthogonal Space Tempering”, http://pubs.acs.org/doi/abs/10.1021/ct200726v, J. Chem. Theory Comput. 2012, 8, 810-823, published Jan. 25, 2012.

Regarding the first aspect, here, we are proposing to generalize the OSRW method to the orthogonal space tempering (OST) technique, which can be described through the following modified energy function shown in Equation (3).

$${U}_{m} = {U}_{o} ( λ ) + {f}_{m} ( λ ) + \frac{{T}_{ES} - {T}_{o}}{{T}_{ES}} {g}_{m} ( λ , {F}_{λ} ) \qquad ( 3 )$$

where gₘ(λ,F_{λ}) is still targeted toward −G_{o′}(λ,F_{λ}); its contribution to the overall potential is scaled by a parameter of (T_{ES}−Tₒ)/T_{ES}; here Tₒ is the system reservoir temperature, and a preset parameter T_{ES} can be called the orthogonal space sampling temperature because of the fact that for any given λ′ state, probability distributions in the target ensemble follow exp[−G_{o′}(λ′,F_{λ})/kT_{ES}], where k is the Boltzmann constant. Thereby, the sampling boundary in the orthogonal space is naturally defined. In regard to the second aspect, the long-time convergence of the ABF recursion strategy has been mathematically proven; therefore, we will employ this recursion approach as a key component of our recursion kernel design to ensure overall free energy recursion robustness.

In the present invention, the double-integration OST (DI-OST) method is described in the context of alchemical free energy simulation (or called the “free energy perturbation” calculation); for the purpose of GE sampling, the dynamics of the scaling parameter λ are introduced via a specially designed extended Hamiltonian scheme. The present double-integration OST (DI-OST) method is demonstrated on alchemical free energy simulations, specifically to calculate the free energy difference between benzyl phosphonate and difluorobenzyl phosphonate in aqueous solution, to estimate the solvation free energy of the octanol molecule, and to predict the nontrivial Barnase-Barstar binding affinity change induced by the Barnase N58A mutation. As shown in these model studies, the DI-OST method is a practically efficient and robust free energy calculation method, particularly when strongly coupled slow environmental transitions are involved.

Through orthogonal space tempering free energy simulations, the relative binding affinities of a classical set of p38α MAP Kinase inhibitors were efficiently calculated. As demonstrated, without any “expert-insight” input throughout the sampling propagations, the chemical accuracy level of relative binding affinity prediction was robustly achieved.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level flow chart illustrating how the invention functions.

FIG. 2 is a high level block diagram illustrating an apparatus for carrying out the invention.

FIG. 3 illustrates the alchemical free energy simulation setup with (a) The thermodynamic cycle, and (b) The illustrative example of the alchemical transition setup.

FIG. 4 illustrates the relative free energy prediction results with (a) The time-dependent changes of the accuracy indexes including RMSD, MUE, and PI, and (b) The comparison between the experimental values and the predicted results. The results predicted at 3.5 ns are shown in blue circles and the final results with the elongated simulation lengths are shown in red circles.

FIG. 5 illustrates the details on the OST simulation of the bound 14 with (a) The binding site structure, (b) The time-dependent changes of the number of the surrounding waters and the λ values, and (c) The two-dimension biasing potential gₘ(λ,θ) adaptively generated in the OST simulation.

### DETAILED DESCRIPTION

The DI-OST Algorithm

The present invention is focused on alchemical free energy simulations, by which protein-ligand binding affinity changes, protein-protein binding affinity changes, solvation energies, pKₐ values, and other chemical state related thermodynamic properties can be predicted. The disclosed DI-OST algorithm is also applicable to the geometry-based potential of mean force calculations.

To carry out alchemical free energy calculations, as described in Equation (1), a scaling parameter λ needs to be introduced to connect two target chemical states. A simplest hybrid energy function is the linear form shown in Equation (4).

U₀(λ)=(1−λ)Uₛ^{A}+λUₛ^{B}+Uₑ (4)

where Uₛ^{A} and Uₛ^{B} are the energy terms unique in the two end chemical states; Uₑ represents the common environmental energy terms shared by the two end states. When dummy atoms are employed in one of the end states, soft-cores potentials are commonly applied to treat the van der Waals terms or/and the electrostatic terms in Uₛ^{A} and Uₛ^{B} to avoid the end point singularity issue.

In GE alchemical free energy simulations, needs to be dynamically coupled with the motion of the rest of the system. Such extended dynamics can be realized either via the hybrid Monte Carlo method, where the scaling parameter jumps along a prearranged discrete λ ladder are enabled through the metropolis acceptance/rejection procedure, or via the λ-dynamics method, where λ moves in the continuous region between 0 and 1 are enabled through an extended Hamiltonian approach. The extended dynamics of the scaling parameter in OSRW are implemented on the basis of the λ-dynamics method. In the original λ-dynamics free energy calculation method, the scaling parameter λ is treated as a one-dimensional fictitious particle. In the present invention, especially to rigorously constrain λ between 0 and 1, a novel θ-dynamics approach is proposed. In this θ-dynamics, λ is set as the function λ(θ); the variable θ is treated as a one-dimensional fictitious particle, which travels periodically between −π and π. In OSRW simulations, uniform distributions are targeted. Here, the usage of the θ-dynamics approach is mainly for the purpose of constraining the λ range; actually, it is preferable to have uniform sampling in the λ space. For the above purpose, the functional form of λ(θ) according to the is designed as shown in Equation (5).

$$λ ( θ ) = \{ \begin{matrix}r {sin}^{2} \frac{θ}{2} , \vert θ \vert \leq {θ}_{o} \\ a θ + b , {θ}_{o} < θ < π - {θ}_{o} \\ - a θ + b , {θ}_{o} - π < θ < - {θ}_{o} \\ r {sin}^{2} \frac{θ}{2} + c , π - {θ}_{o} \leq \vert θ \vert \leq π\end{matrix} \qquad ( 5 )$$

in which r=1/(1−cos θₒ+½(π−2θₒ)sin θₒ), a=r/2 sin θₒ, b=r/2(1−cos θₒ−θₒ sin θₒ), and c=r/2(π−θₒ)sin θₒ+r/2(1−cos θₒ−θₒ sin θₒ)−r sin²((π−θₒ)/2). In Equation (5), θₒ is the parameter utilized to separate the linear region and the end-state (λ=0,1) transition region. In OSRW and OST simulations, θₒ should be set as a tiny value so that A is almost 1 and B is almost zero; thus the Jacobian contribution from the λ(θ) function can be negligible. The propagation and the thermolyzation of the θ particle are based on the Langevin equation, the same as how the λ particle is treated in the original λ-dynamics method.

The OSRW method is based on the modified potential energy function as described in Equation (2). The OSRW algorithm has two recursion components: the recursion kernel to adaptively update gₘ(λ,F_{λ}) toward its target function G_{o′}(λ,F_{λ}) and the recursion slave to adaptively update fₘ(λ) toward its target function −Gₒ(λ) based on the concurrent gₘ(λ,F_{λ}) function. In the original implementation, the metadynamics strategy is employed as the recursion kernel. Specifically, the free energy biased potential gₘ(λ,F_{λ}) can be obtained by repetitively adding a relatively small Gaussian-shaped repulsive potential as explained in Equation (6)

$${h}_{0} exp ( - \frac{{\vert λ - λ ( {t}_{i} ) \vert}^{2}}{2 {w}_{1}^{2}} ) exp ( - \frac{{\vert {F}_{λ} - {F}_{λ} ( {t}_{i} ) \vert}^{2}}{2 {w}_{2}^{2}} ) \qquad ( 6 )$$

which is centered around [λ(tᵢ),F_{λ}(tᵢ)] at the scheduled update time and thereby discourages the system from often visited configurations. With this procedure repeated, the overall biasing potential shown in Equation (7)

$${g}_{m} ( λ , {F}_{λ} ) = {\sum }_{{t}_{i}} {h}_{o} exp ( - \frac{{\vert λ - λ ( {t}_{i} ) \vert}^{2}}{2 {w}_{1}^{2}} ) \times exp ( - \frac{{\vert {F}_{λ} - {F}_{λ} ( {t}_{i} ) \vert}^{2}}{2 {w}_{2}^{2}} ) \qquad ( 7 )$$

will build up and eventually flatten the underlying curvature of the free energy surface in the (λ,F_{λ}) space. Then, the free energy profile along the reaction coordinate (λ,F_{λ}), which should eventually converge to −G_{o′}(λ,F_{λ}), can be estimated as −gₘ(λ,F_{λ}).

Since for a state λ′, the free energy profile along its generalized force direction can be estimated as −gₘ[λ′,F_{λ}(λ′)], the generalized force distribution should be proportional to exp{βₒgₘ[λ′,F_{λ}(λ′)]}, in which βₒ represents 1/(kTₒ). On the basis of the above discussion, free energy derivatives at each state can be obtained as shown in Equation (8).

$$\frac{d {G}_{o}}{d λ} {\vert}_{{λ}^{′}} = {〈 {F}_{λ} 〉}_{{λ}^{′}} = \frac{{\int }_{{F}_{λ}} {F}_{λ} exp \{ {β}_{o} [ {g}_{m} ( λ , {F}_{λ} ) ] \} δ ( λ - {λ}^{′} )}{{\int }_{{F}_{λ}} exp \{ {β}_{o} [ {g}_{m} ( λ , {F}_{λ} ) ] \} δ ( λ - {λ}^{′} )} \qquad ( 8 )$$

Following the TI formula, the free energy change between the initial state with which is the lower bound of the collective variable range, and any target state with the order parameter λ can unfold as a function of λ shown in Equation (9).

$${G}_{o} ( λ ) = {\int }_{{λ}_{i}}^{λ} \frac{d {G}_{o}}{d λ} {\vert}_{{λ}^{′}} d {λ}^{′} \qquad ( 9 )$$

In the original OSRW implementation, the metadynamics strategy, as described in Equation (7), serves as the recursion kernel; the TI based formula (Equations (8) and (9)) serves as the recursion slave with fₘ(λ) recursively set as instantaneously estimated −Gₒ(λ).

On the basis of the above OSRW procedure, we carried out a free energy simulation study on the model system. The model simulation was performed on the basis of two-dimensional Langevin dynamics, where the temperature was set as 50 K and the particle mass was set as 100 g/mol. The OSRW simulation led to a converged free energy profile Gₒ(x) [targeted as −fₘ(x)], and a converged −gₘ(x,∂Uₒ/∂x) (in the model case, ∂Uₒ/∂x is the generalized force), where two energy minima are smoothly connected along ∂Uₒ/∂x at the transition state region. When converged, this represents the residual free energy surface after the free energy surface flattening treatment −gₘ(x,∂Uₒ/∂x) along the order parameter. [−gₘ(x,∂Uₒ/∂x)] reveals the fact that the residual free energy barrier exists around the transition state region. It can be traced along ∂Uₒ/∂x near the transition state, and more importantly, the residual barrier height (about 2.2 kcal/mol) is similar to that of the hidden energy barrier. In this model system, the generalized force can reveal the direction of the order-parameter-coupled hidden process; this is a prerequisite for efficient and accurate calculations of the target free energy profile Gₒ(x).

To further understand the role of ∂Uₒ/∂x and the difference between the OSRW sampling [e.g., based on Uₒ+fₘ(x)+gₘ(x,∂Uₒ/∂x) as in Equation (2)] and the classical generalized ensemble sampling [e.g., based on Uₒ+fₘ(x) as in Equation (1)], we respectively employed the biasing energy functions fₘ(x) and fₘ(x)+gₘ(x,∂Uₒ/∂x), which were obtained in the recursion step, to perform two corresponding equilibrium generalized ensemble simulations. The OSRW sampling allows the system to travel repetitively between two energy minima; as a comparison in the classical generalized ensemble simulation, the system is trapped in the original energy minimum state due to the lack of sampling acceleration along the hidden dimension. Furthermore, according to the umbrella sampling reweighting relationship, the samples collected from the OSRW simulation can be employed to recover the free energy surface along x and y, the well-sampled region of which is the same as the target energy surface. As shown from this recovered free energy surface, the samples are more concentrated along the minimum energy path that connects two energy wells.

In an OSRW simulation, the sampling volume in the orthogonal space increases with the elongation of the simulation length; additionally, the diffusion sampling overhead around the states, where no hidden barrier exists, continuously increases. As mentioned above, the OSRW method can be generalized to the orthogonal space tempering (OST) algorithm. The target energy function of the OST scheme is described in Equation (3). In the OST scheme, free energy surfaces along the generalized force direction are not completely flattened. Then, the orthogonal space effective sampling temperature T_{ES} can impose an effective sampling boundary to ensure the long-time scale convergence. A larger T_{ES} allows more efficient crossing of hidden free energy barriers but introduces more diffusion sampling overhead. Interestingly, when T_{ES} approaches the infinity limit, the OST method becomes the original OSRW algorithm; when T_{ES} approaches the system reservoir temperature Tₒ, the second-order GE sampling turns to the first-order GE sampling as described in Equation (1).

The metadynamics method according to the invention achieves adaptive recursions based on a dynamic force-balancing relationship. Its performance strongly depends on energy surface ruggedness and preset parameters. To improve the convergence behavior of OST, in the present work, we designed an alternative method to gain robust recursions.

Among various recursion methods, the adaptive biasing force (ABF) algorithm has a similar efficiency to that of the metadynamics algorithm. In contrast to the metadynamics technique, the ABF method has been mathematically proven; thus the usage of the ABF method as the recursion kernel, specifically via the calculation of the F_{λ}-dependent free energy profile G_{o′}(λ′,F_{λ}) at each λ′ state, can ensure free energy convergence robustness. A challenging issue remains: how to numerically calculate the generalized force of F_{λ} to estimate target F_{λ}-dependent free energy profiles. As a matter of fact, calculating generalized forces of complex order parameters has been known to be a difficult issue in the ABF algorithm implementation. To circumvent this issue, in our OST implementation, we propose a “dynamic reference restraining” (DRR) recursion strategy. Specifically, the target OST potential described above with reference to Equation (3) is rewritten as Equation (10)

$${U}_{m} = {U}_{o} ( λ ) + \frac{1}{2} {{k}_{Φ} ( {F}_{λ} - Φ )}^{2} + {f}_{m} ( λ ) + \frac{{T}_{ES} - {T}_{o}}{{T}_{ES}} {g}_{m} ( λ , Φ ) \qquad ( 10 )$$

in which the generalized force fluctuation is restrained to the move of another dynamic particle. In Equation (10), fₘ(λ) is still targeted toward −Gₒ(λ), and gₘ(λ,) is targeted toward −G_{o′}(λ,), the negative of the free energy surface along (λ,) in the canonical ensemble with the energy function Uₒ(λ)+½k (F_{λ}−)²−G λ), where G(λ) is the λ-dependent free energy surface in the canonical ensemble with Uₒ(λ)+½k (F_{λ}−)² as the energy function. On the basis of Equation (10), motions along F_{λ} are indirectly activated via the restraining treatment to the dynamic reference. Here, the dynamics of the particle are also realized through the same extended Hamiltonian method as in λ-dynamics or θ-dynamics, which was discussed above.

According to the OST target function in Equation (10), we need to design a recursion kernel to estimate G_{o′}(λ,) in order to adaptively update gₘ(λ,). To obtain the two-dimensional function G_{o′}(λ,), first, the ABF method is directly employed to calculate the-dependent free energy profile at each λ′ state, specifically on the basis of the following TI relationship shown in Equation 11.

$${G}_{{o}^{′}} ( {λ}^{′} , Φ ) = {\int }_{Φ} {〈 \frac{\partial {U}_{{o}^{′}} ( λ , Φ )}{\partial Φ} δ ( λ - {λ}^{′} ) 〉}_{{Φ}^{′}} d {Φ}^{′} \qquad ( 11 )$$

Here, U_{o′}(λ,) represents Uₒ(λ)+½k (F_{λ}−)²; then ∂U_{o′}(λ,φ)/∂φ can be simply evaluated as −k (F_{λ}−). It is noted that the numerical boundary of G_{o′}(λ′,), i.e., the integration boundary in Equation (11), changes as the recursion proceeds. Following the general ABF strategy, <∂U_{o′}(λ,φ)/∂φδ(λ−λ′)>, can be adaptively estimated as shown in Equation (12)

$$\frac{{\sum }_{i} - {k}_{Φ} [ {F}_{λ} ( {t}_{i} ) - Φ ( {t}_{i} ) ] δ [ λ ( {t}_{i} ) - {λ}^{′} ] δ [ Φ ( {t}_{i} ) - {Φ}^{′} ]}{{\sum }_{i} δ [ λ ( {t}_{i} ) - {λ}^{′} ] δ [ Φ ( {t}_{i} ) - {Φ}^{′} ]} \qquad ( 12 )$$

where tᵢ is the ith scheduled sample-collecting time. Equations (11) and (12) only allow the obtaining of the one-dimension function G_{o′}(λ′,) at each λ′ state. The height of the G_{o′}(λ′,) function can be recalibrated as shown in Equation (13)

$${G}_{{o}^{′}} ( {λ}^{′} , Φ ) = {G}_{{o}^{′}} ( {λ}^{′} , Φ ) - {G}_{{o}^{′} , min} ( {λ}^{′} , Φ ) - RT ln {\int }_{Φ} exp ( - \frac{{G}_{{o}^{′}} ( {λ}^{′} , Φ ) - {G}_{{o}^{′} , min} ( {λ}^{′} , Φ )}{{kT}_{o}} ) \qquad ( 13 )$$

where G_{o′,min}(λ′,) is the lowest value in the free energy curve G_{o′}(λ′,); G_{o″}(λ′,) represents the postcalibration function of G_{o′}(λ′,). All of the calibrated one-dimension G_{o″}(λ′,) functions can be assembled to be the target two-dimension G_{o′}(λ,) function. Then, gₘ(λ,) can be adaptively updated as instantaneously estimated −G_{o′}(λ′,). This calibration procedure is based on the gₘ(λ,) function definition in Equation (10), specifically to fulfill the condition that the target energy function for gₘ(λ,) free energy flattening treatment has already been flattened along the direction. In the DI-OST method according to the invention, Equations (11)-(13) constitute the recursion kernel.

Regarding the recursion slave, the TI formula in Equation (9) is still used to estimate Gₒ(λ); then, (dGₒ/dλ)|_{λ′} at each λ′ state needs to be evaluated. Different from the recursion in the original OSRW algorithm, where the target function of the recursion kernel is −G_{o′}(λ,F_{λ}), here, the target function of the recursion kernel −G_{o′}(λ,) does not provide direct information on generalized force F_{λ} distributions. For the fact that F_{λ} is restrained to, a simple but an approximate way of estimating (dGₒ/dλ)|_{λ′} can be made on the basis of the assumption of < >_{λ′}=<F_{λ}>_{λ′}. Thus, (dGₒ/dλ)|_{λ′} can be approximated via Equation (14).

$$\frac{d {G}_{o}}{d λ} {\vert}_{{λ}^{′}} = {〈 {F}_{λ} 〉}_{{λ}^{′}} \approx {〈 Φ 〉}_{{λ}^{′}} = \frac{{\int }_{Φ} Φ exp \{ β [ {g}_{m} ( λ , Φ ) ] \} δ ( λ - {λ}^{′} )}{{\int }_{Φ} exp \{ β [ {g}_{m} ( λ , Φ ) ] \} δ ( λ - {λ}^{′} )} \qquad ( 14 )$$

To more rigorously estimate (dGₒ/dλ)|_{λ′}, G_{o′}(λ′,F_{λ}) needs to be calculated for each λ′ state as described above. Notably, the samples collected at the state λ′ with F_{λ}=F_{λ}′ can be considered as being obtained from multiple independent ensembles, each of which corresponds to a unique restraining reference value ′. According to the umbrella integration relationship, based on the samples from each (λ′,′) restraining ensemble, (dGₒ(λ′,F_{λ})/dF_{λ})|_{Fλ′,λ′} can be estimated as 1/(β₀)(F_{λ}′− F̅_̅{̅λ̅}̅^̅{̅λ̅′̅,̅φ̅′̅}̅)/(σ_{λ}^{λ′,φ′})²−k_{φ}(F_{λ}′−φ′), where F̅_̅{̅λ̅}̅^̅{̅λ̅′̅,̅φ̅′̅}̅ stands for the average of the F_{λ} values of all of the samples in the (λ′,′) restraining ensemble and σ_{λ}^{λ′,′} represents the variance of samples. Using the multihistogram approach to combine the estimations from all of the restraining ensembles that are visited at the λ′ state, (dGₒ(λ′,F_{λ})/dF_{λ})|_{λ′,λ′} can be calculated as shown in Equation (15)

$$\frac{d {G}_{o} ( {λ}^{′} , {F}_{λ} )}{d {F}_{λ}} {\vert}_{{F}_{{λ}^{′} , {λ}^{′}}} = \frac{{\int }_{{Φ}^{′}} ρ ( {Φ}^{′} {λ}^{′} , {F}_{{λ}^{′}} ) [ \frac{1}{{β}_{o}} \frac{{F}_{{λ}^{′}} - \overline{{F}_{λ}^{{λ}^{′} , {Φ}^{′}}}}{{( {σ}_{λ}^{{λ}^{′} , {Φ}^{′}} )}^{2}} - {k}_{Φ} ( {F}_{{λ}^{′}} - {Φ}^{′} ) ]}{{\int }_{{Φ}^{′}} ρ ( {Φ}^{′} {λ}^{′} , {F}_{{λ}^{′}} )} \qquad ( 15 )$$

where ρ(where ρ(_{‘λ’,Fλ′}) denotes the total number of the (λ′,F_{λ}′) samples that are collected from the ′ restraining ensemble.

Then, based on the TI relationship, G_{o′}(λ′,F_{λ}) can be calculated according to Equation (16).

$${\vert {G}_{{o}^{′}} ( {λ}^{′} , {F}_{λ} ) = {\int }_{{F}_{{λ}^{′}}} \frac{d {G}_{o} ( {λ}^{′} , {F}_{λ} )}{d {F}_{λ}} \vert}_{{F}_{{λ}^{′} , {λ}^{′}}} d {F}_{{λ}^{′}} \qquad ( 16 )$$

Again, like in Equation (11), the numerical boundary of G_{o′}(λ′,F_{λ}), i.e., the integration boundary in Equation (16), changes as the recursion proceeds. Following the corresponding derivation in the original OSRW method, we can obtain (dGₒ/dλ)|_{λ′} at the state λ′ using Equation 17.

$$\frac{d {G}_{o}}{d λ} {\vert}_{{λ}^{′}} = {〈 {F}_{λ} 〉}_{{λ}^{′}} = \frac{{\int }_{{F}_{λ}} {F}_{λ} exp \{ - {β}_{o} [ {G}_{{o}^{′}} ( λ , {F}_{λ} ) ] \} δ ( λ - {λ}^{′} )}{{\int }_{{F}_{λ}} exp \{ - {β}_{o} [ {G}_{{o}^{′}} ( λ , {F}_{λ} ) ] \} δ ( λ - {λ}^{′} )} \qquad ( 17 )$$

On the basis of the corresponding TI formula in Equation (9), fₘ(λ), which is targeted as −Gₒ(λ), can then be adaptively updated. In the DI-OST method according to the invention, Equations (15)-(17) and (9) constitute the recursion slave. Notably, fₘ(λ) does not have to be equal to −Gₒ(λ) in a strict manner; here, it is highly recommended to employ the approximate approach based on Equations (11)-(14) and (9) to update fₘ(λ), and the more rigorous approach based on Equations (15)-(17) and (9) to estimate Gₒ(λ), because of the fact that < >_{λ′} in Equation (14), is directly estimated from-space ABF calculations (Equations (11) and (12)) and should converge faster. In the DI-OST method, both the recursion kernel and the recursion slave are based on the integration schemes. Therefore, it is named the double-integration recursion method.

The double-integration recursion based OST method is implemented in the “orthogonal space sampling module”, which is currently coupled with our customized CHARMM program. See, Brooks, B. R.; Bruccoleri, R. E.; Olafson, B. D.; States, D. J.; Swaminathan, S.; Karplus, M. CHARMM: A program for macromolecular energy, minimization, and dynamics calculations. J. Comput. Chem. 1983, 4, 187-217 and Brooks, B. R.; Brooks, C. L.; Mackerell, A. D.; Nilsson, L.; Petrella, R. J.; Roux, B.; Won, Y.; Archontis, G.; Bartels, C.; Boresch, S.; Calfisch, A.; Caves, L.; Cui, Q.; Dinner, A. R.; Feig, M. Feig; Fischer, S.; Gao, J.; Hodoscek, M.; Im, W.; Kuczera, K.; Lazaridis, T.; Ma, J.; Ovchinnikov, V.; Paci, E.; Pastor, R. W.; Post, C. B.; Pu, J. Z.; Schaefer, M.; Tidor, B.; Venable, R. M.; Woodcock, H. L.; Wu, X.; Yang, W.; York, D. M.; Karplus, M. CHARMM: The biomolecular simulation program. J. Comput. Chem. 2009, 30, 1545-1614. CHARMM is available from Harvard University.

In the present invention, the following van der Waals soft-core potential form is employed to treat the atoms which are annihilated as illustrated in Equation (18)

$${U}_{“ softcore ” vdW} = ( 1 - λ ) [ \frac{A}{{( {α}_{vdW} {λ}^{2} + {r}^{6} )}^{2}} - \frac{B}{{α}_{vdW} {λ}^{2} + {r}^{6}} ] \qquad ( 18 )$$

where α_{vdW} is the van der Waals soft-core shifting parameter. It is noted that Equation (18) is different from the one in the currently released CHARMM program. The electrostatic soft-core potential is based on Equation (19)

$${U}_{“ softcore ” elec} = \frac{( 1 - λ ) {Q}_{A} {Q}_{B}}{\sqrt{{α}_{elec} λ + {r}^{2}}} \qquad ( 19 )$$

where α_{elec} is the electrostatic soft-core shifting parameter. In Equations (18) and (19), the annihilation is assumed to occur at the state of λ=1; to be consistent, in this study, all of the dummy atoms are set at the state of λ=1.

In the present invention, the DI-OST method is demonstrated in the context of alchemical free energy simulation, specifically to calculate the free energy difference between benzyl phosphonate and difluorobenzyl phosphonate in aqueous solution, to estimate the solvation free energy of the octanol molecule, and to predict the Barnase-Barstar nontrivial binding affinity change induced by the Barnase N58A mutation.

The molecules of benzyl phosphonate (BP) and difluorobenzyl phosphonate (F2BP) are the side chain analogues of prototypical phosphotyrosine mimetics, which are common targets in drug discovery. The free energy difference between these two molecules in aqueous solution, λG_{BP→F2BP}^{aqueous}, has been used as a test-bed to analyze free energy simulation methods. In practical studies, if combined with the free energy difference in gas phase λG_{BP→F2BP}^{gas}, ΔG_{BP→F2BP}^{aqueous}−ΔG_{BP→F2BP}^{gas} gives rise to the value of the solvation energy difference; if combined with the free energy difference in a protein binding site ΔG_{BP→F2BP}^{protein}, ΔG_{BP→F2BP}^{protein}−ΔG_{BP→F2BP}^{aqueous} gives rise to the value of the binding free energy difference. Here, the test calculations on ΔG_{BP→F2BP}^{aqueous} are used to comparatively evaluate the original OSRW method and the invention's DI-OST method in the aspects of algorithm robustness and long-time convergence. On the basis of each of the two methods, five sets of independent simulations were carried out. The MD simulation setup was the same as the one in the earlier studies, where the BP and F2BP molecules are described with the CHARMM22 parameter. In total, 294 water molecules are included in the truncated octahedral box; the water molecules are treated with the TIP3P model. The diagram below shows the setup of the alchemical transition from BP to F2BP.

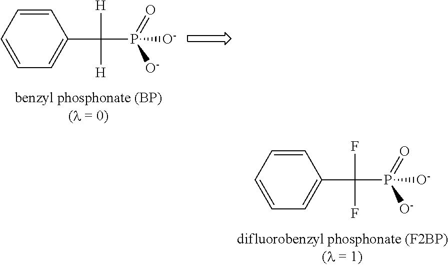

For the fact that there is no vanishing atom in either of the end states, the linear hybrid energy function (as described by Equation (4)) is used in this model study.

In the five OSRW simulations, g(λ,F_{λ}) (in Equation (7)) was updated every 10 time steps; the height of the Gaussian function h was set as 0.01 kcal/mol; the widths of the Gaussian function, ωᵢ and ω₂, were set as 0.01 and 4 kcal/mol respectively; and fₘ(λ) was updated (based on Equations (8) and (9)) once per 1000 time steps. In the five DI-OST simulations, the samples were collected every time step; g(λ,) was updated (based on Equations (11)-(13)) once per 1000 time steps; fₘ(λ) was updated (based on Equations (17-19) and (9)) once per 1000 time steps; and T_{ES} was set as 600 K (the system reservoir temperature is 300 K). The length of each simulation is 20 nanoseconds (ns).

The model calculation on the octanol solvation free energy is to understand the role of the orthogonal space sampling temperature T_{ES}. The octanol molecule which is described by the CHARMM general force field (CGFF), is embedded in a truncated octahedral water box with a total of 713 TIP3P water molecules. In the alchemical free energy simulation setup, the solvated octanol molecule (λ=0) is changed to a gas phase molecule (λ=1), which does not have any interaction with the solvent molecules. Accordingly, all of the van der Waals and the electrostatic energy terms describing the solute-solvent interactions are subject to the soft-core treatment, in which α_{vdW} is set as 0.5 and α_{elec} is set as 5.0. Then, the solvation free energy of octanol G_{octanol}^{solvaton} can be estimated as the negative of the free energy difference −ΔG_{λ=0→λ=1} between the two end states.

To understand the influence of T_{ES} on sampling efficiency, two sets of independent DI-OST simulations were run, each of which includes eight simulations with T_{ES} respectively set as 750 and 375 K (the system reservoir temperature is 300 K). The samples were collected every time step. gm(λ,) was updated (based on Equations (11)-(13)) once per 1000 time steps. fₘ(λ) was also updated (based on Equations (17-19) and (9)) once per 1000 time steps. The length of each simulation is 17 ns.

The model study on the binding between barnase, an extracellular RNase of Bacillus amyloliquefaciens, and barstart, the intracellular polypeptide inhibitor of barnase demonstrates the DI-OST method in predicting mutation induced protein-protein binding affinity changes. The barnase N58A mutation is located at the second layer of the binding interface; this noncharging mutation causes about 3.1 kcal/mol of the binding affinity loss. The DI-OST simulations were performed to calculate the alchemical free energy changes in two environments: ΔG_{Asn→Ala}^{complex} in the barnase-barstar complex and ΔG_{Asn→Ala}^{barnase} in the unbound barnase. The binding affinity change ΔΔG_{Asn→Ala} can be calculated as ΔG_{Asn→Ala}^{complex} ΔG_{Asn→Ala}^{barnase}. All of the systems are treated with the CHARMM27/CMAP model. In the model for the ΔG_{Asn→Ala}^{complex} calculation, the barnase-barstar complex (with the PDB code of 1BRS) is embedded in the octahedral box with 18 902 water molecules; in the model for the ΔG_{Asn→Ala}^{barnase} calculation, the unbound barnase (also based on the PDB code of 1BRS) is embedded in the octahedral box with 11 291 water molecules.

In the alchemical free energy simulation setup shown in the diagram below, the vanishing atoms in Asn58 (λ=0) are switched to the corresponding dummy atoms at λ=1. The bond, angle, and dihedral terms associated with the dummy atoms are set identical to the corresponding ones of the original asparagine residue. All of the van der Waals terms and the electrostatic energy terms associated with the dummy atoms are subject to the soft-core treatment, in which α_{vdW} was set as 0.5 and α_{elec} was set as 5.0. The three DI-OST simulations were performed with T_{ES} set as 1500 K (the system reservoir temperature is 300 K); the samples were collected every time step. g(λ,) was updated (based on Equations (11-13)) once per 1000 time steps. fₘ(λ) was also updated (based on Equations (17-19) and (9)) once per 1000 time steps.

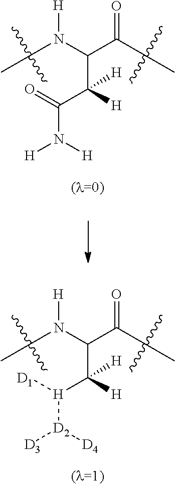

The CGFF parameters were generated through the CHARMM-GUI server. The particle mesh ewald (PME) method 63 was applied to take care of the long-range columbic interactions while the short-range interactions were totally switched off at 12 Å. The Nóse-Hoover method was employed to maintain a constant reservoir temperature at 300 K, and the Langevin piston algorithm was used to maintain the constant pressure at 1 atm. The time step was set as 1 fs.

The results from one of the five DI-OST simulations are summarized as follows. In about 800 ps, the scaling parameter λ completed the first one-way trip, which started at λ=0. It is noted that free energy estimations are only possible when the sampling covers the entire λ space. At 820 ps, the initial estimation of ΔG_{BP→F2BP}^{aqueous} gives 299.91 kcal/mol, which is very close to the finally converged result 299.77 kcal/mol. In the DI-OST scheme, the ((T_{ES}−Tₒ)/T_{ES})gₘ(λ,) biasing term enables the accelerating of moves, which through the restraint term ½k (F_{λ}−)² induces simultaneous fluctuation enlargement of the generalized force F_{λ}. In these simulations, the restraint force constant k was set as 0.1 (kcal/mol)⁻¹; F_{λ} and are robustly synchronized. The recursive orthogonal space tempering treatment allows F_{λ} fluctuations to be continuingly enlarged until around 8 ns; then the space sampling boundary imposed by T_{ES} was reached. Subsequent recursion kernel and recursion slave updates enable continuous refinement of the gₘ(λ,) and fₘ(λ) terms. At the end of the 20 ns simulation, the orthogonal space sampling temperature 600 K allows the fluctuations of and F_{λ} to overcome ˜9KT strongly coupled free energy barriers that are hidden in the orthogonal space.

The BP and D2BP molecules differ only in their local polarity. One would expect moderate environment changes to be associated with the target alchemical transition; simulating the BP-D2BP transition may not fully demonstrate the sampling power of the DI-OST method. However, for its simplicity, this is an ideal system to test the robustness and the long-time convergence behavior of a free energy simulation method. The estimated free energies from the five DI-OST simulations converge to the average value of 299.77 kcal/mol, which quantitatively agrees with the results obtained from the classical free energy simulation studies. Notably, as mentioned above, in this model study, we only targeted our calculations on the estimation of the alchemical free energy difference ΔG_{BP→F2BP}^{aqueous}, the value of which alone does not have any physical meaning. With 20 ns of the simulation lengths, the variance of the five independently estimated values is as low as 0.01 kcal/mol. Within only 940 picoseconds (ps), all five DI-OST simulations had completed their first one-way trips. Then, the average of the estimated values is 299.82 kcal/mol, and the variance of the calculation results is 0.12 kcal/mol. In 2 ns, the average of the estimated values converges to 299.79 kcal/mol, and the variance of the calculation results is 0.04 kcal/mol. In DI-OST simulations, Gₒ(λ) [the negative of fₘ(λ)] should converge faster than G_{o′}(λ,) [the negative of gₘ(λ,)] because of the fact that the free energy derivative dGₒ(λ)/dλ is largely determined by the lower region of the free energy surface along (λ,F_{λ}). Besides the sampling efficiency, the DI-OST method provides free energy estimation robustness and long-time convergence rigorousness.

As discussed above, the original OSRW method is limited in two aspects. First, the orthogonal space sampling temperature T_{ES} is effectively infinity; thus, there is no boundary to restrict the magnitude of F_{λ} fluctuation enlargement. The orthogonal space free energy surface flattening treatment enlarges F_{λ} fluctuations boundlessly. In comparison with the DI-OST simulations, which have their sampling boundaries imposed by the finite T_{ES} value (600 K), the OSRW simulations have ever-increasing sampling coverage. Consequently, both the average and the variance of the free energy results show time-dependent oscillatory behaviors. Second, the original OSRW method is based on the metadynamics recursion kernel. The metadynamics kernel provides extra dynamic boosts on λ moves. Then, the first one-way trips can be quickly completed (around 350 ps in average). Although the free energy estimations could be started earlier, both of the short-time and long-time convergence behaviors of the OSRW simulations are not nearly as good as those of the DI-OST simulations. For example, at 2 ns, the average of the free energy values from the OSRW simulations converges to 299.97 kcal/mol, and the variance of these results is about 0.10 kcal/mol. The metadynamics sampling in the OSRW simulations is by nature in the nonequilibrium regime; in comparison, the sampling in the DI-OST simulations starts in the near-equilibrium regime and rigorously approaches the equilibrium regime with the converging of the two recursion target functions. The robustness and the convergence behavior of OSRW simulations can be improved with the decreasing of the employed Gaussian height; however, it is expected that then the orthogonal space recursion (the recursion kernel) efficiency will be lower and the gₘ(λ,F_{λ}) convergence will be slower.

The DI-OST algorithm allows the orthogonal space sampling strategy to be more robustly realized for free energy simulations. It should be noted that although in the above comparison, better robustness and long-time convergence behavior of the DI-OST simulations have been demonstrated; indeed, within the simulated time scale, the absolute performance of the OSRW simulations is also expected to be superior.

Among various alchemical free energy simulation applications, solvation free energy calculations are unique because of the fact that they may require extensive sampling but the results are still quantitatively verifiable by classical free energy simulations. In this study, we carried out solvation energy calculations on the octanol molecule to understand the role of the orthogonal space sampling temperature T_{ES} in the DI-OST method.

As discussed above, the sampling length required to achieve the first one-way trip is a key factor in sampling efficiency measurement. The average of the first one-way trip sampling lengths in the eight T_{ES}=750 K DI-OST simulations is 1.6 ns; the variance of these sampling lengths is 0.53 ns. In comparison, the average of the first one-way trip sampling lengths in the eight T_{ES}=375 K DI-OST simulations is 3.57 ns, and the variance of the first one-way trip sampling lengths is 0.63 ns. The sampling bottleneck is located in the region of λε(0.7, 0.8); infrequent crossing of this region slows down overall λ round-trip diffusivity. The solute appearance/annihilation transition is the major event in this sampling bottleneck region. It is noted that due to the employment of the soft-core potential, the solute appearance/annihilation transition is shifted from λ=1, the expected region when the linear hybrid alchemical potential is applied, to this new region. Solvent molecule reorganizations are the “hidden” events that are associated with solute insertions/annihilations. When the orthogonal space sampling temperature T_{ES} is higher (for example 750 K), the magnitude of the F_{λ} fluctuation is expected to be larger and hidden free energy barriers associated with solvent reorganizations can be more quickly crossed; thereby, the sampling of the bottleneck region can be more efficient.

With regard to the time-dependent averages of the estimated desolvation free energies from the eight T_{ES}=750 K DI-OST simulations, and the time-dependent variances of the estimated desolvation free energies from the eight T_{ES}=750 K DI-OST simulations, at around 2 ns, the average of the estimated values is 3.45 kcal/mol and the variance of these values is about 0.23 kcal/mol. At around 6 ns, the average of the estimated values drops to around 3.35 kcal/mol, while their variance decreases to 0.17 kcal/mol. At around 13.5 ns, the free energy estimations reach very nice convergence with the average value of 3.36 kcal/mol, and the estimation variance drops below 0.1 kcal/mol. By the inclusion of the long-range Lennard-Jones correction (0.79 kcal/mol), the predicted solvation energy, −4.15±0.1 kcal/mol, is in excellent agreement with the experimental value −4.09 kcal/mol. At 17 ns, a nicely converged gₘ(λ,) function was obtained with the variance further reduced to 0.08 kcal/mol. The orthogonal space sampling temperature 750 K allows the fluctuations of and F_{λ} to quickly escape ˜5 kT strongly coupled free energy barriers. In comparison, the eight T_{ES}=350 K DI-OST simulations have smaller sampling coverage in the orthogonal space. The lack of sampling in the orthogonal space not only leads to the longer sampling length requirement for the first one-way trips as discussed above but also leads to the slower convergence. At 17 ns, some of the T_{ES}=350 K DI-OST simulations have not yet converged well because of the fact that the variance among them is still larger than 0.1 kcal/mol. As a result, the average of these values is about 0.05 kcal/mol away from the average of the values estimated from the T_{ES}=750 K simulations. With T_{ES}=350 K, the orthogonal space sampling treatment temperature 350 K only allows the fluctuations of and F_{λ} to escape less than 2 kT strongly coupled hidden free energy barriers.

As shown in the above analysis, the orthogonal space tempering treatment allows the sampling bottleneck regions, where hidden free energy barriers exist, to be more efficiently explored. If there is no hidden free energy barrier in the orthogonal space, a higher orthogonal space sampling temperature T_{ES} may introduce more diffusion sampling overhead, which might lower free energy estimation precision. In practical biomolecular simulation studies, there usually exist large hidden free energy barriers, and then, obtaining accurate free energy estimation should be a higher priority than improving estimation precision, as long as the estimation precision is in a reasonable range. On the basis of our experience, when a new system is explored, we would like to recommend setting T_{ES} in a range between 750 and 1500 K.

It has been known that charge-charge interactions are directly responsible for the strong binding between Barnase and Barstar. The Barnase Asn58 residue is located at the second layer of the binding interface. As measured experimentally, the noncharging N58A mutation causes 3.1 kcal/mol of the binding affinity loss. This unusual electrostatic response suggests that nontrivial conformational changes are likely to be coupled with the N58A mutation. To quantitatively understand the N59A induced binding affinity change, a specialized technique like the DI-OST method should be applied to ensure adequate sampling of the coupled structural transitions. To confidently sample such conformational changes, in the DI-OST simulations, T_{ES} is set at 1500 K.

Two DI-OST simulations, which are respectively based on the Barnase-Barstar (bound) complex structure and the Barnase (unbound) structure, were performed. In 4 ns, multiple λ round-trips were realized in both of the DI-OST simulations. It took the bound-state simulation only 1.1 ns to complete the first one-way trip, while it took the unbound-state sampling about 1.8 ns to cover the entire order parameter range. The dynamics of the scaling parameter λ in the unbound-state simulation reveals that the region of λ=0.4 is the sampling bottleneck area, where slow gating events need to occur for λ continuing travels. In 4 ns, good convergence was realized in both of the free energy simulations. Through the DI-OST recursion treatment, the λ-dependent free energy derivatives dGₒ/dλ were calculated; the binding affinity change ΔG_{Asn→Ala} is largely responsible for the difference that occurs near the alanine state (λ=1), where the two free energy derivative curves are distinct from each other. As discussed below, the conformational change of the mutated (N58A) Barnase induced by the binding/unbinding of Barstar is mainly responsible for ΔΔG_{Asn→Ala}. On the basis of the TI formula (Equation (9)), ΔG_{Asn→Ala}^{complex} is 1 estimated to be 94.0 kcal/mol and ΔG_{Asn→Ala}^{Barnase} is estimated to be 91.1 kcal/mol; thus ΔΔG_{Asn→Ala} can be predicted to be 2.9 kcal/mol, which is in excellent agreement with the experimental value of 3.1 kcal/mol. The orthogonal space tempering treatment allows the fluctuations of and F_{λ} to overcome λ12-14 kT of the strongly coupled hidden free energy barriers.

The comparison of the crystal structures (1BRS and 1BNR) suggests that the Barnase protein has the identical conformation at the bound and the unbound states. The Barnase Asn58 is located on a Barstar-binding loop, but at the opposite side from the binding interface residues, for instance, Arg59. In these structures, the binding interface region on the Arg59-containing loop is zipped by the hydrogen bond between the amide group of Gly61 and the carbonyl group of Asn58; thereby Arg59 can be accurately positioned into the binding site. This zipped structure is further locked by two additional hydrogen bonds between the Asn58 side chain and the backbone amide/carbonyl groups. In the bound-state DI-OST simulation, with residue 58 repeatedly interconverted between the two end chemical states: asparagine and alanine, the structure of the Arg59-containing loop stayed unchanged, even when λ approached the alanine state (λ=1). The hydrogen bond between the amide group of Gly61 and the carbonyl group of Asn58 was not broken during the entire simulation. The fluctuation of the distance between residues 58 and 63 was modest. In contrast, in the unbound-state simulation, synchronously with the λ move, the Arg59-containing loop varied back and forth between the original zipped conformation (at the asparagine state when λ=0) and a newly formed unzipped conformation (at the alanine state when λ=1). When residue 58 turned to alanine, the distance between residues 58 and 63 increased, and when λ traveled back to the asparagine state, the canonical hydrogen bonds between these two residues were formed again. Correspondingly, the zipping hydrogen bond repetitively broke and reformed. On the unzipped loop of the unbound N59A mutant, Arg59 flips away from its wild-type gesture that is originally preorganized to bind Barstar.

The above analysis suggests that there is strong coupling between the Barnase-Barstar binding and the Arg59-containing loop zipping, and Asn58 plays a pivotal role in prestabilizing the zipped conformation of the Arg59-containing loop when Barnase is in the unbound state. Therefore, the Barnase-Barstar binding can be enhanced. When Asn58 is mutated to alanine, the Arg59-containing loop in the unbound Barnase is unzipped due to the loss of both the locking hydrogen bonds by Asn58 and the binding of the Barstar. When the N58A mutant binds Barstar, some free energy penalty needs to be paid in order to form the bound conformation, which, as revealed by the bound state DI-OST simulation, stays zipped in the Barstar-bound state regardless of the existence of Asn58. The two simulations share the similar free energy derivative curves near the asparagine (λ=0) state; this indicates that there is only modest contribution from the direct electrostatic interaction difference to the binding affinity change. In essence, the binding affinity change induced by the N58A mutation is largely responsible for the mutation-induced conformational change at the unbound state. The DI-OST method allows the corresponding conformational change to be synchronously sampled with the λ moves; therefore, the binding affinity change can be efficiently predicted.

The simulations described above were performed using a 16-core Intel 3.2 GHz cluster. However, as discussed below, other computing platforms may be preferred.

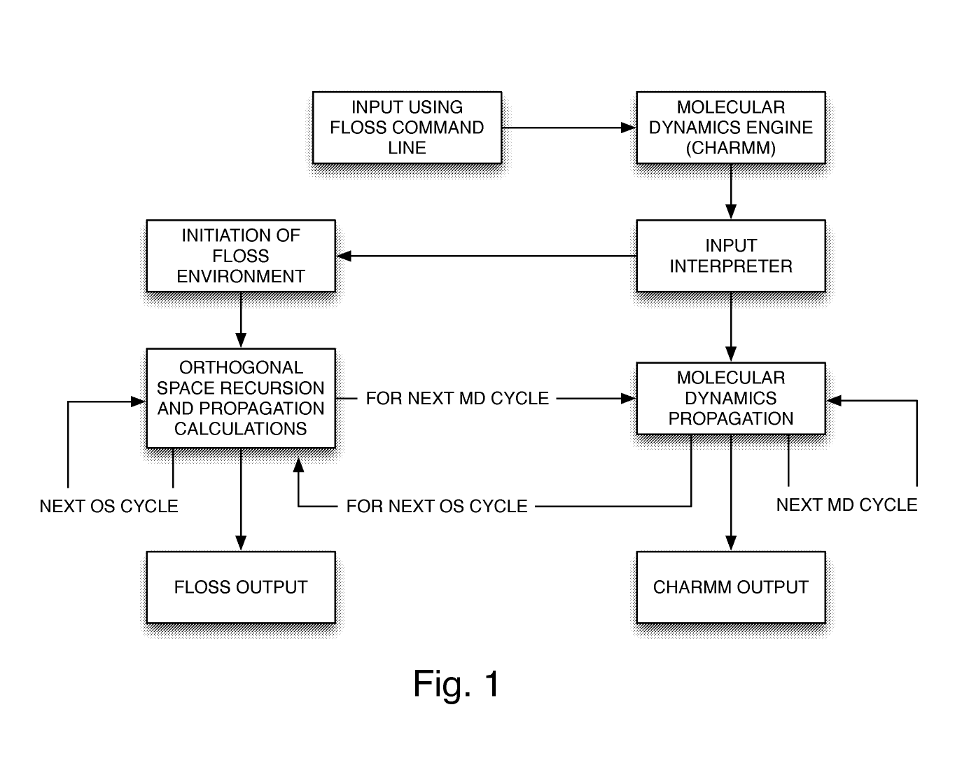

Turning now to FIG. 1, the invention is realized with the implementation of two pieces of software: a modified version of CHARMM and FLOSS (which is the software that implements the above-described orthogonal space recursion and propagation calculations). The FLOSS software can be obtained from Florida State University.

As shown, input is provided using the FLOSS command line interface. The code listing below shows an example of the input:

!!!!!!! OSRW ======================================================
BLOCK 3
call 2 sele none end
call 3 sele none end
RMLA BOND THET !DIHE IMPH !RMBOnd and RMANgle work only in lambda-dynamics.
QLDM THETa TYP2 THE0 0.00001
LANG temp 300.0
!LDIN BLOCKnum LAMBda LamVelocity LamMass ReferenceE
LDIN 1 1.0 0.0 100.0 0.0 200.0
LDIN 2 1.0 0.0 100.0 0.0 200.0
LDIN 3 0.0 0.0 100.0 0.0 200.0
LDMA ! key word for convert lambdas into coefficient matrix
end
set ndyn 20000000
open unit 48 form write name gauss.dat
open unit 49 form write name gauss.rst
open unit 77 form write name Flambda.dat
open unit 78 form write name Flambda-fitting-parameters.dat
open unit 88 form write name free.dat
open unit 9 form write name dvdl.dat
!open unit 55 form write name wtmp.dat
!open unit 66 form write name fitting.dat
!open unit 67 form write name fitting.rst
! Turn on umbrella sampling fitting facilities
umbrella lamb nresol 100 trig 30 poly 20
umbrella init nsim 1000 update 10000 equi 1000 thresh 100000 temp 300
umbrella stoff
set fqrestart 1000 ! use the same output frequency for gauss.rst, Flambda-fitting-parameters.dat,
and @j_dyn1.res.
open unit 60 form write name g2d.dat
open unit 61 form write name g2d.rst
open unit 39 form write name flc.dat
open unit 29 form write name lamct.dat
! Turn on OSRW
OSRW QABF BSOR 4 UG2D −60 UGRS 61 -
DURS TMASa 0.00005 TTEMp 300.0 TBETa 500.0 TFORCeconst 0.05 -
RMME MLEN 5000 SLEN @ndyn MAXR 5000 -
UFLC 39 UNCL 29 -
QGS2 GSFA 0.9 -
ND2S 5 CCAD 5 GCBO 20.0 GCON 25.0 QFLC FTOS −200 -
MINLambda 0.0 MAXLambda 1.0 BINLambda 100 - ! minimum, maximum lambda (always 0
and 1 respectively for alchemical free energy simulation)
- ! and number of bins
MINDudl −400.0 MAXDudl 600.0 BINDudl 1000 - ! minimum, maximum dU/dlambda and
number of bins

| | |
|---|---|
| HGAUssian 0.0 - | ! Gaussian height |

| | |
|---|---|
| WGALambda 0.01 WGADudl 2.0 - | ! Widths for lambda and dU/dlambda |

| | |
|---|---|
| FQAGaussian 1 - | ! frequency to add one Gaussian count |

| | |
|---|---|
| FQOGaussian @fqrestart - | ! frequency to output Guassian counts |

| | |
|---|---|
| UNOGaussian −48 UNGRestart 49 - | ! units for Gaussian counts output and restart files |

| | |
|---|---|
| W4SM 5 - | ! Cutoff bin numbers for Gaussian energy calculation |
| FQDUdl 10 - | ! frequency to output dvdl.dat |
| UNDudl 9 - | ! unit for dvdl.dat |
| FQFRee 100 - | ! frequency to output free.dat |
| UNFree 88 - | ! unit for free.dat |
| FITLambda 1000 - | ! frequency to update F(lambda) |
| FITOutput @fqrestart - | ! frequency to output Flambda.dat and Flambda-fitting- |
| parameters.dat | |
| NBLFitting 200 - | ! number of bins of lambda for F(lambda) |
| NBDFitting 2000 - | ! number of bins of dU/dlambda for F(lambda) |

| | |
|---|---|
| DUBC 0.001 DUBHeight −3.0 - | ! cutoffs for <dU/dlambda> calculation |

| | |
|---|---|
| FITUnit 77 FTPU 78 - | ! units for Flambda.dat and Flambda-fitting- |

parameters.dat
NOCEntering
!!!!!!!! END OSRW
======================================================

The input is then sent to the CHARMM molecular dynamics engine which passes it to an input interpreter. The input interpret interpreter sends some input to the FLOSS environment and some to the CHARMM environment. These two software engines operate in parallel and pass information to each other as illustrated. Both engines perform recursive calculations. CHARMM calculates molecular dynamics and FLOSS performs orthogonal space calculations. Two outputs are provided in the form of molecular trajectory and the free energy information from FLOSS, and a regular MD output from CHARMM. These outputs can be used to predict the most viable new drug candidates.

The FLOSS output includes four data files called dvd1.dat, flc.dat, free.dat, and g2d.pm3d.dat. The file “dvd1.dat” gives the time-dependent parameter changes. The file “flc.dat’ gives the current free energy related information. The file “free.dat” gives the time-dependent estimated free energy values. The file “g2d.pm3d.dat” gives the orthogonal space free energy surface information A snippet example of each file is listed below.

0 1.0000000 39.997488 73.154030 −33.156542 3.1415927 0.0000000
73.154030 −33.156542 0.0000000 0.0000000 0.0000000 0.0000000
10 0.99708939 −36.283837 15.564164 −51.848001 3.1324437
−0.23703498E−01 20.052203 −53.326373 −405.14451 −177.87914
0.89760770E−01 −0.29567442E−01
20 0.99539778 −19.519949 32.634796 −52.154745 3.1271294
−0.14915055 35.771960 −56.894757 251.89787 28.301134
0.62743291E−01 −0.94800234E−01
30 0.99166579 −20.173132 35.976338 −56.149470 3.1154051
−0.26341060E−01 31.543365 −60.959727 −173.40017
−121.16818 −0.88659460E−01 −0.96205139E−01
40 0.98581450 −9.6569670 40.567302 −50.224269 3.0970227
−0.92541334E−01 28.119055 −54.267326 −272.34691
−311.89749 −0.24896494 −0.80861144E−01

dvdl.dat

```
0.500000E−02  136.265  0.00000  0.00000  0.00000
  0.150000E−01  136.265  1.36265  0.00000  0.00000
  0.250000E−01  136.265  2.72529  0.00000  0.00000
  0.350000E−01  136.265  4.08794  0.00000  0.00000
  0.450000E−01  136.265  5.45059  0.00000  0.00000
  0.550000E−01  136.265  6.81324  0.00000  0.00000
  0.650000E−01  136.265  8.17588  0.00000  0.00000
  0.750000E−01  136.265  9.53853  0.00000  0.00000
  0.850000E−01  136.265  10.9012  0.00000  0.00000
  0.950000E−01  136.265  12.2638  0.00000  0.00000
```

flc.dat

1000 100.000000
2000 100.000000
3000 100.000000
4000 83.694128
5000 84.032298
6000 84.492292

free.dat

0.6450000 61.50000 −49.50000
0.6450000 61.50000 −48.50000
0.6450000 61.50000 −47.50000
0.6450000 61.50000 −46.50000
0.6450000 61.50000 −45.50000
0.6450000 61.50000 −44.50000
0.6450000 61.50000 −43.50000
0.6450000 61.50000 −42.50000

g2d.pm3d.dat

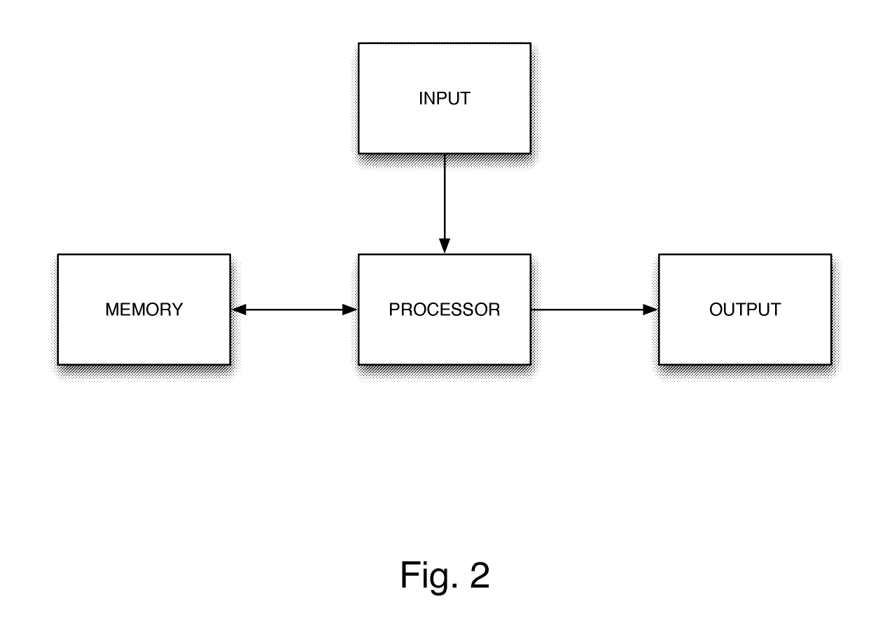

Turning now to FIG. 2, an apparatus for implementing the invention includes a processor with associated memory, an input and an output. As mentioned above, the test simulations were performed with a 16-core Intel 3.2 GHz cluster. However, it is believed that other computing platforms may be preferred. In particular, it is believed that GPUs are more powerful in implementing the invention than CPUs. The NVIDIA GPU platform (http://www.nvidia.com/object/gpu-applications/html) is the presently preferred platform.

### Orthogonal Space Tempering Simulation Study of p38α MAP Kinase Inhibitors

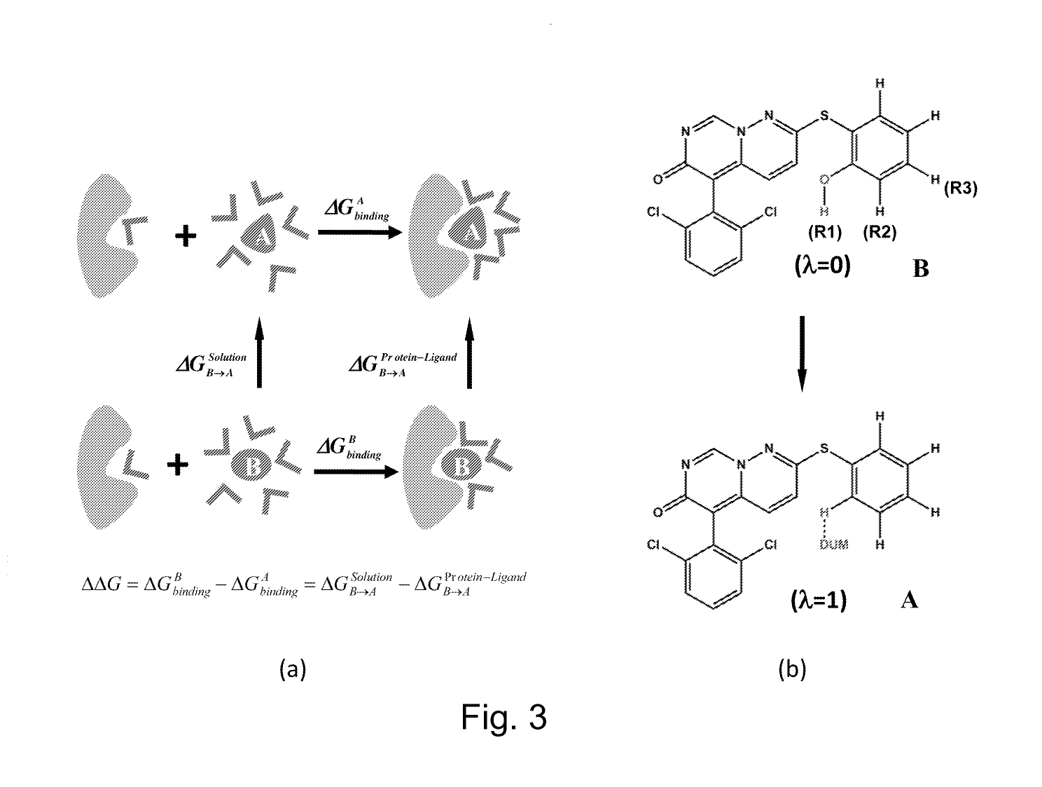

The p38αMAP Kinase inhibitor dataset consists of 17 molecules with a common scaffold (FIGS. 3a and 3b). Computational prediction of the relative binding affinity via the alchemical thermodynamic cycle in FIG. 3a can be considered as a quantitative analogue of intuitive assessment of an alternative substitution group in lead optimization by medicinal chemists. The p38α MAP Kinase inhibitor test-system is unique for the fact that non-additive effects such as protein binding site dynamics and water displacements may make non-trivial contributions. Therefore, the relative binding efficacies are challenging to predict either by chemical intuitions or via more approximate methods. When “brute-force” MD propagations are applied, extensive simulation lengths are required to adequately sample these subtle effects. In an OST free energy simulation, through the effective tempering treatment along the generalized force direction, the sampling of environmental relaxations can be simultaneously enhanced. In the present study, the orthogonal space sampling temperature was set as 1500 K in order to gain quicker exploration of environmental responses.

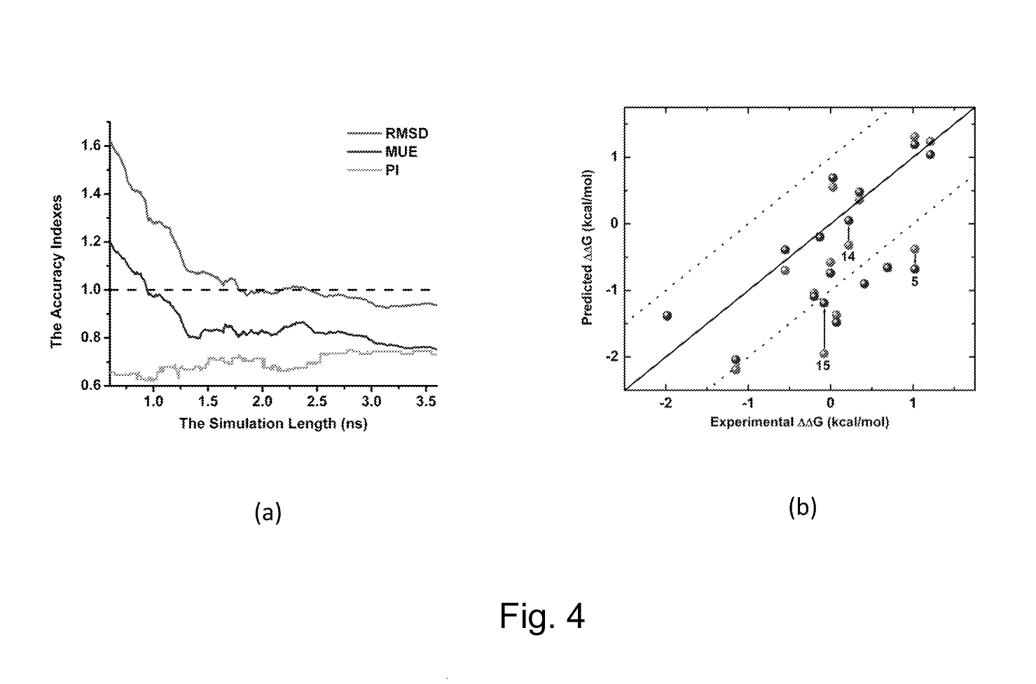

In the OST scheme the data collection for single free energy calculation is made through one continuous simulation. As elaborated in the supporting information, the target-state B and the reference-state A (FIG. 3b) are connected in an alchemical potential, based on which the dynamics of the order parameter λ is propagated via the extended Hamiltonian formulation. Treated by the OST strategy, round-trip moves of the λ particle between the two end states (the state B: λ=0; and the reference state A: λ=1) are efficiently accelerated and the alchemical transition can thereby be repetitively sampled. According to the thermodynamic cycle in FIG. 3a, one relative binding affinity prediction requires two OST simulations: one on the protein-ligand complex and the other on the solvated ligand in a water box that is usually much smaller than the one containing the protein-ligand complex. Thus, the overall computing cost is mostly the time spent on the protein-ligand OST simulations. In the present study, compound 1 is employed as the common reference state A. As shown in FIG. 3b, when the target compound, for instance 14, has excess number of atoms, the soft-core potentials were applied to treat the annihilated atoms. Notably, compounds 4 to 17 have two possible binding poses, the “exposed” conformer when the R1 and R2 groups directly face the bulk water and the “buried” conformer where the R1 and R2 groups flip away from the binding entrance residues (FIG. 4). These two binding poses are likely to be separated by large free energy barriers. Thus in order to confidently assess each of these compounds, two independent ligand-bound OST simulations were performed: one based on the “exposed” conformer to calculate ΔG_{B(exposed)→A}^{Protein-Ligand}; and the other, depending on the convenience of setups, either based on the “buried” conformer to calculate ΔG_{B(buried)→A}^{Protein-Ligand} or via the pseudo-alchemical approach to directly estimate ΔG_{B(exposed)→B(buried)}^{Protein-Ligand}. To ensure the broad meaningful of the present prediction study, the ligands were treated with a general GAFF/AM1-BCC potential, the protein was described by the AMBER94 force field, and the solvent water was described by the TIP3P model; moreover, all the MD setups including the parameter generations were automatically obtained through the CHARMM-GUI web-server. (See, e.g., Wang, J. M.; Wolf, R. M.; Caldwell, J. W.; Kollman, P. A.; Case, D. A. Development and testing of a general AMBER force field. J. Comput. Chem. 2004, 25, 1157-1174; and Jo, S.; Kim, T.; Iyer, V. G.; Im, W. CHARMM-GUI: A web-based graphical user interface for CHARMM. J. Comput. Chem. 2008, 29, 1859-1865.)

The experimental relative binding free energies were estimated based on the measured −log(IC₅₀) values. The time-dependent comparison between the experimental relative binding free energies and the prediction results shows that in 2.5 ns of each of the protein-ligand simulations, the overall RMSD was lowered to be within 1.0 kcal/mol; the overall mean unsigned error (MUE) was lowered to be within 0.8 kcal/mol; and the overall predictive index (PI), which is to represent the ranking order correlation, was increased to be above 0.76. These accuracy indexes robustly improved with the elongation of the simulation lengths; for instance at 3.5 ns, the prediction accuracy was enhanced to 0.92 kcal/mol of RMSD, 0.77 kcal/mol of MUE, and 0.76 of PI. As discussed earlier, on compounds 4 to 17, two set of the OST simulations were performed to respectively estimate the binding free energies of the two possible poses; the above comparison analysis is based on the lower estimated binding free energy of each compound. In ΔG_{B(exposed)→B(buried)}^{Protein-Ligand} (or ΔG_{B(exposed)→A}^{Protein-Ligand}−ΔG_{B(buried)→A}^{Protein-Ligand}) calculations converged relatively fast so that the dominant binding pose of each of these compounds could be clearly distinguished within 1.0 ns. As identified, among all of these compounds, only 13 and 17 favor the buried pose; these two compounds are structurally distinct from the others in that both the R1 and R3 positions are occupied by hydrophobic moieties. The identified poses are largely consistent with the results from an earlier study except for the case of 13. In this early study, based on its identified exposed conformer, the binding free energy of 13 was significantly overestimated. “Chemical accuracy” has been defined as the situation when the overall prediction error is less than 1.0 kcal/mol. Although chemical accuracy is an essential target, how to robustly achieve such accuracy is an equally important issue because a “predictive” method needs to be robustly applicable beyond a group of experts, who usually know how to use their great insights to bias sampling decisions. In this regard, the results of the present study are particularly meaningful for the fact it demonstrates the possibility for an automated sampling procedure to efficiently enable the chemical accuracy level of predictions. Those skilled in the art will appreciate that here “chemical accuracy” is not defined in a strict manner for the fact that binding affinities are not always linearly proportional to the −log(IC₅₀) values and five out of the 16 estimations have their individual unsigned errors larger than 1.0 kcal/mol (FIG. 4b).

As mentioned above, the p38α MAP Kinase inhibitor dataset has been known to be a challenging test bed; more approximate approaches often fail in satisfactorily reproducing the experimental values due to their inadequate description of non-additive effects such as water displacements. Moreover, the relative binding affinity range is as narrow as 2-3 kcal/mol, which corresponds to ˜100 fold potency range. A recent pioneering effort was made to address this issue by pre-sampling water molecules around the binding site. Although this pre-sampling treatment allows the prediction accuracy to be improved to the level of 1.44 kcal/mol of RMSD, 0.92 kcal/mol of MUE, and 0.61 of PI, still in this earlier study, complex “educated” procedures were needed and hundreds of folds of the sampling steps (the Monte Carlo steps) were required. Comparably, the OST method allows a similar accuracy level to be acquired within 1.0 ns of the sampling length for each of the protein-ligand simulations. It is noted that because different force fields are employed, the above efficiency comparison is only conditionally informative. In each of the free energy calculations, before the OST simulation, only a short (50 pico-seconds) canonical MD simulation was employed to slightly equilibrate the system for the fact that by the self-healing nature, OST simulations do not need to begin with fully equilibrated structures. Overall, the MD lengths required by OST are even shorter than (at most equivalent to) those required by popular approximate methods such as the MM/PBSA method.

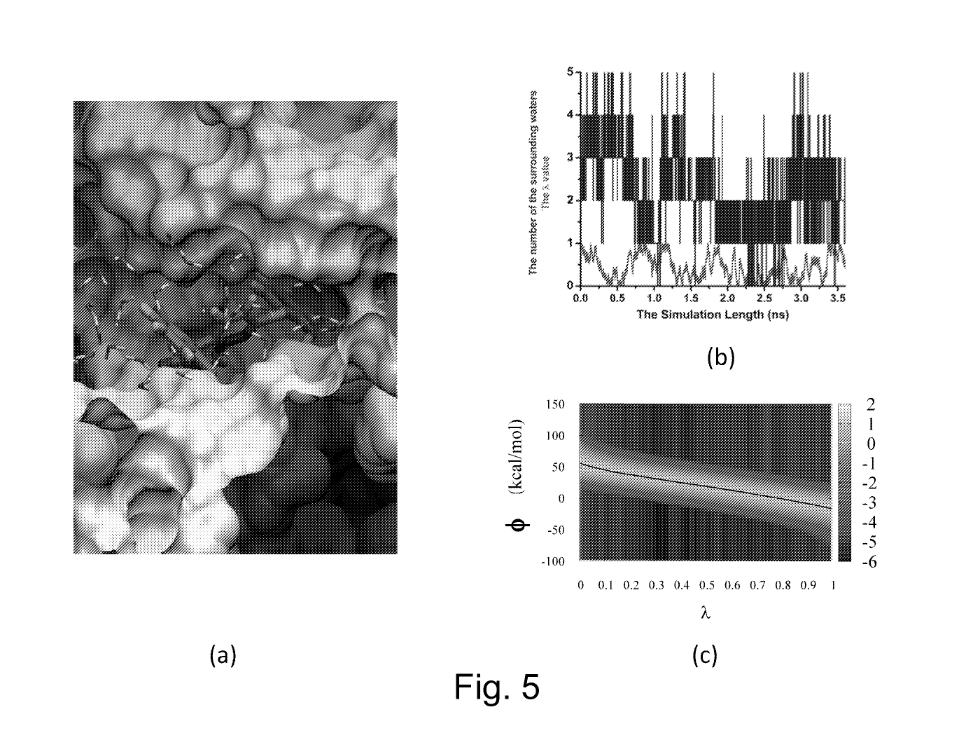

To examine the long-time convergence behavior and the prediction robustness, the length of the simulation on each of the protein-ligand complexes was further elongated. Due to the heterogeneity of the sampling lengths (ranging from 4 ns to 9 ns), the final results are simply shown by the blue circles in FIG. 4b. Most of the prediction results stayed unchanged. Only in three systems, the changes are relatively significant (FIG. 4b); the prediction accuracy on 14 and 15 was enhanced by >0.5 kcal/mol and the prediction accuracy on 5 was slightly lowered by 0.25 kcal/mol. Interestingly, calculating the relative binding affinities of 14 and 15 has been known to be sampling-costly. As shown in FIG. 5a, which illustrates the binding pocket surrounding compound 14, the R1 group (the hydroxyl group in 14) is closely behind the deeper binding entrance; and its polarity directly influences the displacement of neighboring water molecules and the opening/closure of the nearby binding entrance. Therefore, in order to quantitatively simulate the alchemical transition between a target state with a polar group at the R1 position, such as 14 or 15, and the reference state 1 with a hydrophobic phenyl ring at the same location, adequate sampling of possible slow environmental relaxations is pivotal. In the orthogonal sampling scheme the generalized force is employed as the order parameter to describe strongly-coupled orthogonal space motions; the enlargement of its fluctuation via the effective tempering treatment in the OST method allows the sampling of slow motions that gate order parameter transitions to be specifically accelerated. In the simulation on 14 (FIG. 5b), with the moves of the order parameter λ, the number of the water molecules surrounding R1 (within 5 Å) synchronously fluctuated, largely between 1 and 5. The two-dimension biasing potential gₘ(λ,θ), which was adaptively obtained during the OST simulation, is shown in FIG. 5c. In the algorithm, the generalized force is restrained to θ; this potential reveals the fact that the orthogonal space sampling temperature 1500 K allows the fluctuation of the generalized force to overcome ˜8 KT strongly-coupled free energy barriers that are hidden in the orthogonal space, such as the barriers responsible for water displacements and binding entrance opening/closure.

In this work, a very general force field, which could be built automatically through a web-server, was employed; the acquired accuracy is surprisingly encouraging. Certainly, to gain better accuracy, particularly to improve the PI value to more confidently distinguish drug candidates that are in an even narrower potency range, the quality of employed potential energy functions needs to be improved. The unprecedented efficiency observed in the present study also sheds light on the feasibility of applying more advanced energy models in predicting protein-ligand interactions. Currently, we are actively coupling the OST algorithm with a fast MD engine, GROMACS (See, e.g., Van der Spoel, D.; Lindahl, E.; Hess, B.; Groenhof, G.; Mark, A. E.; Berendsen, H. J. C. GROMACS: Fast, flexible, and free. J. Comput. Chem. 2005, 26, 1701-1718) based on the observed efficiency, meeting the pharmaceutical-industry lead optimization requirement, “predictions in two days”, is within reach. Moreover, the “minimum-human-input” feature of automated sampling methods can be appealing to industrial drug discovery processes as well. Although challenging, the p38α MAP Kinase inhibitor dataset certainly cannot represent all the possible complex scenarios; further test studies on varieties of datasets will be performed, in particular on the situation when no confident protein-ligand complex structure is available.

There have been described and illustrated herein several embodiments of methods and apparatus for double-integration orthogonal space tempering. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A method for predicting a chemical state, comprising:
orthogonal space tempering through orthogonal space sampling temperature.

2. The method according to claim 1, further comprising:
double integration recursion.

3. The method according to claim 2, wherein:
the double integration recursion is based on dynamic reference restraining.

4. The method according to claim 3, wherein:
the method provides an output selected from the group consisting of
the free energy difference between benzyl phosphonate and difluorobenzyl phosphonate in aqueous solution,
an estimate of the pKₐ value of a buried titratable residue, Glu-66, in the interior of the V66E staphylococcal nuclease mutant, and
the binding affinity of xylene in the T₄ lysozyme L₉₉A mutant.

5. A system for predicting a chemical state, said system embodied on a computer readable medium coupled to a processor and comprising:
means for accepting input;
means for performing orthogonal space tempering through orthogonal space sampling temperature based on said input; and
means for providing output.

6. The system according to claim 5, wherein:
said input includes a molecular structure and an energy function.

7. The system according to claim 6, wherein:
said output includes molecular trajectory and free energy.

8. The system according to claim 5, further comprising:
means for performing double integration recursion.

9. The system according to claim 8, wherein:
the double integration recursion is based on dynamic reference restraining.

10. The system according to claim 5, wherein:
said output is selected from the group consisting of
the free energy difference between benzyl phosphonate and difluorobenzyl phosphonate in aqueous solution,
an estimate of the pKₐ value of a buried titratable residue, Glu-66, in the interior of the V66E staphylococcal nuclease mutant, and
the binding affinity of xylene in the T₄ lysozyme L₉₉A mutant.

11. A computer readable medium containing program instructions for predicting a chemical state, wherein execution of the program instructions by one or more processors of a computer system causes the one or more processors to carry out the steps of:
accepting input;
performing orthogonal space tempering through orthogonal space sampling temperature based on said input; and
providing output.

12. The computer readable medium according to claim 11, wherein:
said input includes a molecular structure and an energy function.

13. The computer readable medium according to claim 12, wherein:
said output includes molecular trajectory and free energy.

14. The computer readable medium according to claim 11, wherein:
said steps include performing double integration recursion.

15. The computer readable medium according to claim 14, wherein:
the double integration recursion is based on dynamic reference restraining.

16. The computer readable medium according to claim 11, wherein:
said output is selected from the group consisting of
the free energy difference between benzyl phosphonate and difluorobenzyl phosphonate in aqueous solution,
an estimate of the pKₐ value of a buried titratable residue, Glu-66, in the interior of the V66E staphylococcal nuclease mutant, and
the binding affinity of xylene in the T₄ lysozyme L₉₉A mutant.
